(19) United States
(12) Patent Application Publication
(10) Pub. No.: US 2020/0314520 A1
(43) Pub. Date: Oct. 1, 2020

(54) SYSTEMS AND METHODS FOR PROVIDING AN EARPIECE

(71) Applicants: Daniel Rhondeau, Salt Lake City, UT (US); Steven Rhondeau, Salt Lake City, UT (US)

(72) Inventors: Daniel Rhondeau, Salt Lake City, UT (US); Steven Rhondeau, Salt Lake City, UT (US)

(21) Appl. No.: 16/832,332

(22) Filed: Mar. 27, 2020

Related U.S. Application Data
(60) Provisional application No. 62/824,885, filed on Mar. 27, 2019.

(51) Int. Cl. H04R 1/10

(52) U.S. Cl. CPC H04R 1/1016

(57) ABSTRACT

Systems and methods for magnetically coupling an earpiece to a user's ear are described herein. While the described systems can include any suitable component, in some cases, they include an earphone accessory that includes an elongated object, an earphone coupler disposed that is configured to couple the elongated object to the earphone, and a magnetic coupling mechanism. In some cases, the elongated object is configured such that, when a user is wearing the earphone coupled to the elongated object, the elongated object wraps around an ear of the user, from the earphone at a front side of the user's ear to a back side of the user's ear. In some cases, the magnetic coupling mechanism is configured to magnetically couple a first portion of the elongated object to a second portion of the elongated object, through the user's ear. Other implementations are described.

### CROSS-REFERENCE TO RELATED APPLICATION

This application claims priority to U.S. Provisional Application No. 62/824,885 (Attorney Docket No. 29125.2), which was filed on Mar. 27, 2019, and which is entitled SYSTEMS AND METHODS FOR PROVIDING AN EARPIECE; the entire disclosure of which is hereby incorporated herein.

### BACKGROUND OF THE INVENTION

### Field Of The Invention

The present invention relates to earpieces, such as earphones. More particularly, some implementations of the described invention relate to systems and methods for magnetically coupling an earpiece to a user's ear. While the described systems can include any suitable component, in some cases, they include an earphone and an earphone accessory. Generally, the earphone accessory includes an elongated object (or strap), an earphone coupler that is configured to couple the elongated object to the earphone, and a magnetic coupling mechanism. In some cases, the elongated object is configured such that, when a user is wearing the earphone coupled to the elongated object, the elongated object wraps around the user's ear, from the earphone at a front side of the user's ear to a back side of the user's ear. In some cases, the magnetic coupling mechanism is configured to magnetically couple a first portion of the elongated object to a second portion of the elongated object, through the user's ear, to selectively secure the earphone to the user's ear. In some cases, the magnetic coupling mechanism is configured to allow the elongated object to be magnetically coupled to itself in multiple locations, so as to allow the earphone accessory to be used with ears of a variety of sizes and with a variety of different characteristics.

### Background and Related Art

Small loudspeaker drivers that are worn on, in, around, or near a person's ears are often generally referred to as headphones. By wearing headphones, a person can listen to an audio source privately, and without necessarily exposing others who are in proximity to that person to audio from the audio source. Additionally, headphones can reduce the size of the loudspeaker drivers (or simply speakers) that are needed to convey audio to an individual. Thus, headphones can sometimes: require relatively small amounts of energy to function properly, allow their user to listen to audio while easily carrying the headphones with them, require relatively small amounts of space for storage, and otherwise provide users with a convenient way to privately listen to audio.

In order to ensure that headphones stay in place with respect to a user's ears, many headphones are equipped with one or more headphone retention components. For instance, many headphones include a headband that extends between a pair of headphones and that is configured to extend over (or around) a user's head. In another example, some headphones comprise a flexible ear tip that is configured to extend into a user's ear canal to frictionally secure a corresponding headphone to a user's ear. Similarly, some earphones comprise a component that is configured to rest in (and/or to frictionally retain a headphone within) a user's outer ear. Indeed, in some cases, a headphone itself is sized and shaped to be retained within an ear by fitting between the ear's tragus, antitragus, and/or any other suitable anatomical features. In still another example, however, some headphones comprise a hook that is configured to extend over a top portion of a user's ear to help keep a headphone in place.

While many conventional methods for keeping a headphone on or in proximity to a user's ear are useful, such methods are not necessarily without their shortcomings. Indeed, in some cases, conventional methods for retaining headphones in proximity to a user's ears can allow the headphones to be easily jostled out of place. Additionally, in some cases, pressure exerted by a headphone retention mechanism (e.g., by a flexible ear tip) on a user's ear canal can be annoying. Moreover, while some headphone retention components fit some ears relatively well, some such components may not be comfortable for use with ears having a different size and/or shape.

Thus, while systems and methods currently exist that are used to retain headphones in proximity to a user's ears, some challenges still exist, including those listed above. Accordingly, it would be an improvement in the art to augment or even replace current techniques with other techniques.

### SUMMARY OF THE INVENTION

The present invention relates to earpieces, such as earphones. More particularly, some implementations of the described invention relate to systems and methods for magnetically coupling an earpiece to a user's ear. While the described systems can include any suitable component, in some cases, they include an earphone and an earphone accessory. Generally, the earphone accessory includes an elongated object (or strap), an earphone coupler that is configured to couple the elongated object to the earphone, and a magnetic coupling mechanism. In some cases, the elongated object is configured such that, when a user is wearing the earphone coupled to the elongated object, the elongated object wraps around the user's ear, from the earphone at a front side of the user's ear to one or more positions along a back side of the user's ear. In some cases, the magnetic coupling mechanism is configured to magnetically couple a first portion of the elongated object to a second portion (and/or to a plurality of portions) of the elongated object, through the user's ear, to selectively secure the earphone to the user's ear. In some cases, the magnetic coupling mechanism is configured to allow the elongated object to be magnetically coupled to itself in multiple locations, so as to allow the earphone accessory to be used with ears of a variety of sizes and with a variety of different characteristics.

In some implementations, while the earphone coupler is disposed at a first end of the elongated object, a first magnetic material is disposed at a second end of the elongated object. Additionally, in some cases, one or more additional magnetic materials are disposed between the earphone coupler and the first magnetic material. Indeed, in some cases, a second material comprising an elongated magnetic strip is disposed between the earphone coupler and the first magnetic material. In some other cases, however, multiple pieces of magnetic material are disposed between the earphone coupler and the first magnetic material.

In some cases, the earphone coupler is permanently attached to the earphone. For instance, in some implementations, the earphone coupler is glued to, melted to, permanently pinched by, formed with, clasped to, plugged into, snapped together with, clipped to, frictionally engaged with, mechanically engaged with, welded to, and/or otherwise permanently coupled to the earphone. In some other cases, however, the described earphone coupler of the earphone accessory is configured to selectively attach to, and to detach from, the earphone. As a result, one earphone accessory (e.g., the elongated object or strap and/or other components of the accessory) can readily be switched with another. In this regard, the earphone coupler can selectively attached to (and be detached from) the earphone in any suitable manner, including, without limitation, through one or more magnetic coupling mechanisms, sliding coupling mechanisms, male to female mating mechanisms, frictional coupling mechanisms, mechanical coupling mechanisms, hook and loop fasteners, adhesives, threaded attachments, snaps, snap mechanisms, fasteners, catches, clips, hooks, and/or in any other suitable manner.

Although the earphone accessory can comprise any other suitable feature, in some cases the earphone accessory comprises one or more: conductive materials that are configured to be electrically coupled (e.g., via a wired, wireless, and/or in any other suitable manner) to the earphone's battery (e.g., to help charge the earphone's batteries), antennas that are configured to be in signal communication with the earphone (e.g., to help improve the earphone's signal reception and/or transmission), batteries that are configured to be electrically coupled to the earphone (e.g., allowing an uncharged battery that once powered an earphone to be readily replaced with a charged battery by simply changing the earphone accessory on the earphone), pieces of magnetic tape, waterproof and/or waterproofing materials, types of fabric, pieces of plastic, pieces of rubber, pieces of molded material, intertwined materials, pieces of cloth, pieces of metal, reflective materials, fluorescent materials, glow in the dark materials, and/or any other suitable component and/or material.

While the methods and processes of the present invention may be particularly useful for coupling conventional or novel earphones to a user's ears, those skilled in the art will appreciate that the described systems and methods can be used in a variety of different applications and in a variety of different areas of manufacture. For instance, the described systems and methods can be used not only with earphones, but (in some implementations) are configured to be used with hearing aids, earplugs, ear protection, sound cancelling ear protection, hearing protection, headsets (e.g., a unit comprising an earphone and a microphone), any other suitable and relatively small loudspeaker drivers that can be used in proximity to a user's ears, and/or other suitable earpieces that are configured to be retained on, in, over, and/or in proximity to a user's ear or ears, and that are capable of being used with the described systems and methods.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above-recited and other features and advantages of the present invention are obtained, a more particular description of the described inventions will be rendered by reference to specific embodiments thereof, which are illustrated in the appended drawings. Understanding that the drawings are not necessarily drawn to scale or in proper proportion, and that the drawings depict only typical embodiments of the present inventions and are not, therefore, to be considered as limiting the scope of the inventions, the present inventions will be described and explained with additional specificity and detail through the use of the accompanying drawings in which:

FIG. 1A illustrates a front side perspective view of an earphone comprising an earphone accessory in accordance with a representative embodiment;

FIG. 1B illustrates a back side view of the earphone comprising the earphone accessory in accordance with a representative embodiment;

FIGS. 1C-1E each illustrate a schematic view of a different embodiment of the earphone comprising the earphone accessory, wherein in the various earphones and earphone accessories are detached from each other;

FIGS. 1F-1I each illustrate a schematic view of a different embodiment of the earphone comprising the earphone accessory, wherein in the various earphones and earphone accessories are detached from each other;

FIGS. 2A-2B each illustrate a different view showing a different embodiment of the earphone and earphone accessory coupled to a user's ear;

FIGS. 3A-3D provide various views of some embodiments of the earphone and earphone accessory coupled to the user's ear;

FIG. 4 illustrates a top view of an earphone charger in accordance with a representative embodiment;

FIG. 5 illustrates a representative system that provides a suitable operating environment for use with some embodiments of the described system; and

FIG. 6 illustrates a representative embodiment of a networked system that provides a suitable operating environment for use with some embodiments of the described system.

### DETAILED DESCRIPTION OF THE INVENTION

The present invention relates to earpieces, such as earphones. More particularly, some embodiments of the described invention relate to systems and methods for magnetically coupling an earpiece to a user's ear. While the described systems can include any suitable component, in some cases, they include an earphone and an earphone accessory. Generally, the earphone accessory includes an elongated object (or strap), an earphone coupler that is configured to couple the elongated object to the earphone, and a magnetic coupling mechanism. In some cases, the elongated object is configured such that, when a user is wearing the earphone coupled to the elongated object, the elongated object wraps around the user's ear, from the earphone at a front side of the user's ear to a back side of the user's ear. In some cases, the magnetic coupling mechanism is configured to magnetically couple a first portion of the elongated object to a second portion of the elongated object, through the user's ear, to selectively secure the earphone to the user's ear. In some cases, the magnetic coupling mechanism is configured to allow the elongated object to be magnetically coupled to itself in multiple locations, so as to allow the earphone accessory to be used with ears of a variety of sizes and with a variety of different characteristics.

As used herein, the term earpiece and variations thereof may refer to any suitable component that can be worn on, in, over, around, and/or in proximity to a user's ear. Some examples of such earpieces include, without limitation, earphones, earplugs, hearing protection, hearing aids, earphones, and/or the earphone accessories described herein.

As used in herein, term earphone and variations thereof may refer to any suitable speaker system that can be coupled to a user's ear in accordance with some embodiments of the described systems and methods. Some examples of such earphones include, but are not limited to, one or more headphones, ear speakers, ear buds, ear pieces, circum-aural headphones, supra-aural headphones, cans, open-back headphones, closed-back headphones, hearing aids, in ear monitors (or IEMs), in-ear headphones, mixed fitting pivoting earphones, passive noise reduction earphones, active noise reduction earphones, wired earpieces comprising one or more speakers, wireless earpieces comprising one or more speakers (e.g., Bluetooth earpieces, radio earpieces, infrared reception earpieces, digital enhanced cordless telecommunications earpieces, and/or other suitable wireless earpieces), headsets (e.g., units comprising both a speaker and a microphone), corded headsets, wireless headsets, wireless earpieces that are corded together, single earpieces (e.g., mono earpieces), double earpieces (e.g., mono to both ears, stereo, surround sound, high definition, standard definition, and/or any other suitable double earpieces), and/or any other suitable earpiece that comprises one or more speakers and that can be used with at least one embodiment of the described invention. Indeed, in some cases, the term earphone may be used herein to refer to an earbud, ear speaker, headset, and/or other suitable device that comprises a speaker and that can be worn on, in, over, around, and/or in proximity to a user's ear with the assistance of one or more embodiments of the earphone accessory described herein.

The following disclosure of the present invention is grouped into two subheadings, namely “Earphone Accessory” and “Representative Operating Environment.” The utilization of the subheadings is for convenience of the reader only and is not to be construed as being limiting in any sense.

### Earphone Accessory

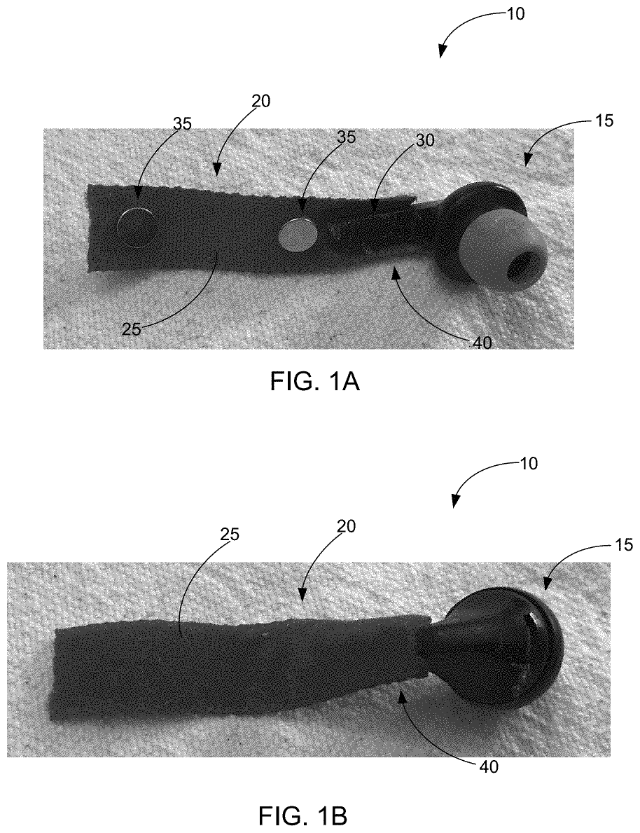

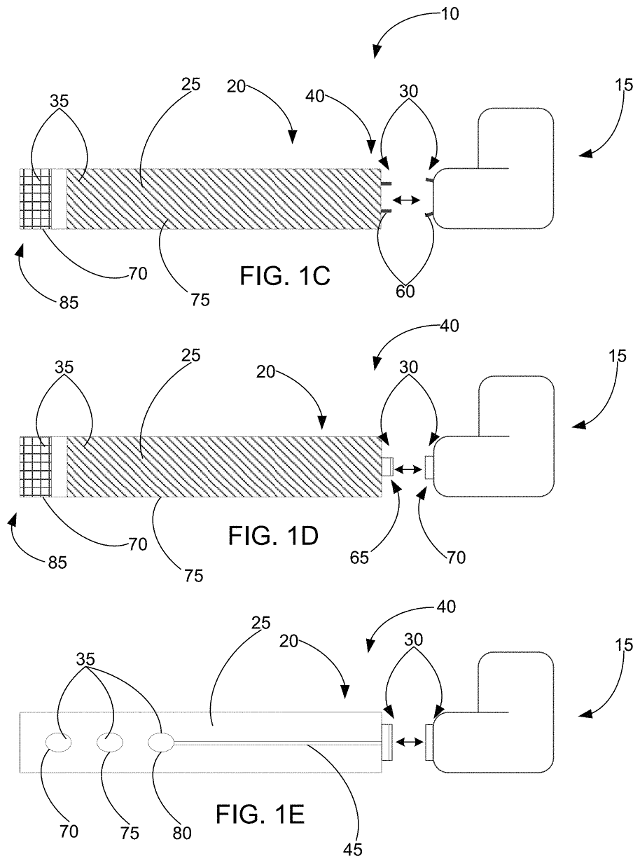

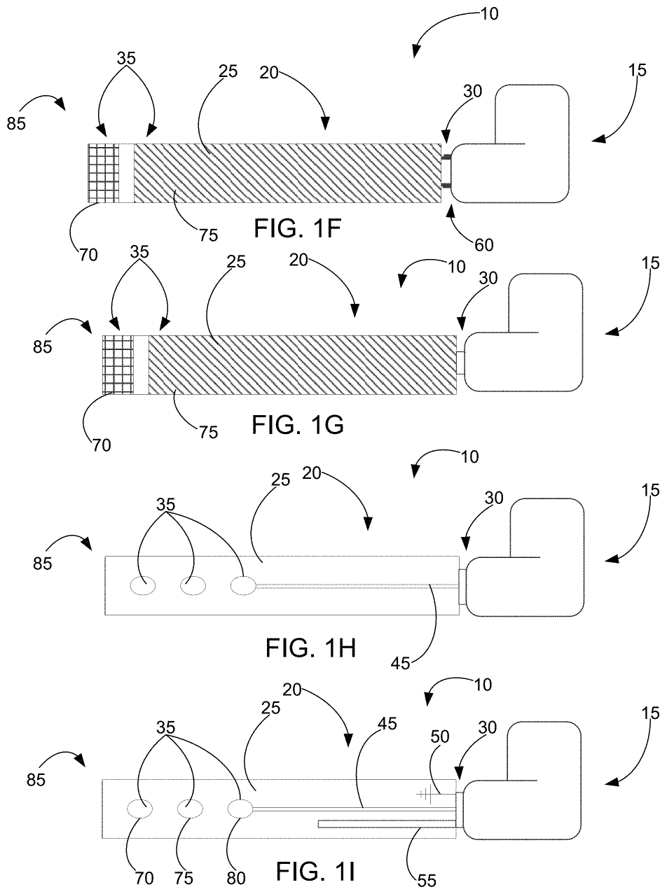

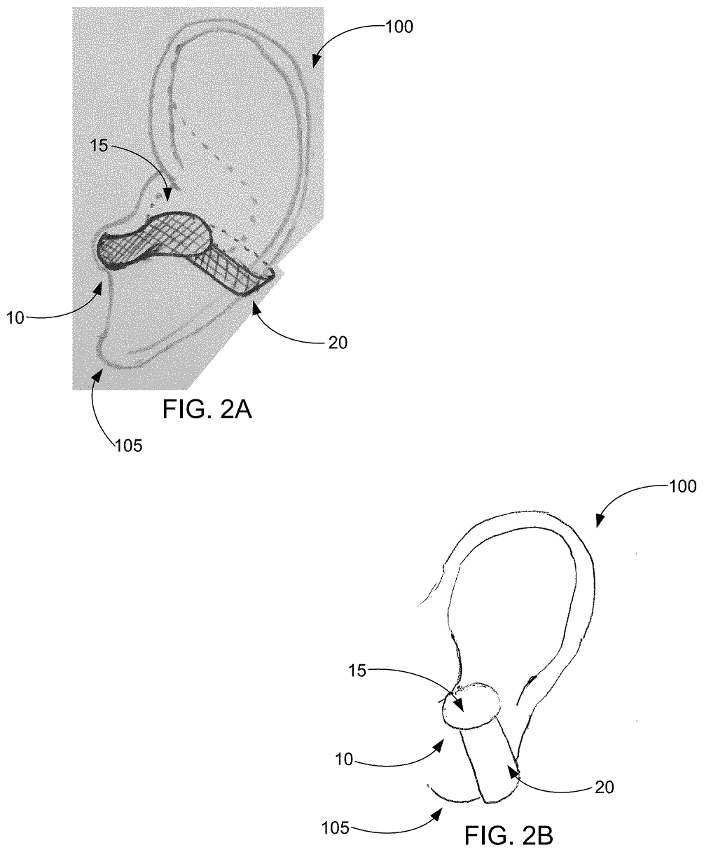

As mentioned, some embodiments of the described invention relate to systems and methods for coupling an earpiece to a user's ear. While such an earpiece can comprise any suitable component, FIG. 1A shows that, in some embodiments, the earpiece 10 comprises an earphone 15 and an earphone accessory 20. In this regard, the earphone can comprise any conventional or novel earphone (from any manufacturer) that is capable of being used with the described earphone accessory. Additionally, the earphone accessory can comprise any suitable component that allows it to magnetically couple such an earphone to a user's ear. By way of non-limiting example, FIGS. 1A-1I show that some embodiments of the earphone accessory 20 comprise one or more elongated objects 25 (or straps), earphone couplers 30, and/or magnetic coupling mechanisms 35.

With respect to the elongated object 25 (or strap), the accessory 20 can include any suitable elongated object or strap that is configured to couple to an earphone 15, to wrap around from the earphone at a front side of a user's ear to a back side of the user's ear (when the user is wearing the earpiece 10), and to be magnetically (and/or or otherwise) coupled to itself (via the magnetic coupling mechanism 35, and/or any other suitable coupling mechanism) through the user's ear. Some non-limiting examples of suitable elongated objects comprise one or more straps, sleeves, belts, bands, ribbons, cables, ropes, wires, strings, sashes, chains, piercings, objects that extend to a piercing, and/or other suitable elongated objects that are capable of functioning as described herein. Moreover, the elongated objects can comprise any suitable material, including, without limitation, one or more pieces of: leather, suede, rubber, cloth, linen, denim, metal, magnetic materials, magnetic tape, wire, cable, rope, canvas, natural material, synthetic material, plastic, polymer, and/or any other suitable material or any suitable combination of materials that allows the elongated object (or strap) to function as described herein. Indeed, in some embodiments, the elongated object comprises a sleeve of a material (e.g., leather, plastic, rubber, fabric, etc.) that houses a magnetic material (e.g., one or more: pieces of magnetic tape, magnets, magnetic gels, magnetized metals, magnetized materials, ferrous magnetic materials, and/or any other suitable magnetic material, as discussed below).

The elongated object 25 (or strap) can be any suitable shape that allows it to function as described herein. Indeed, in some cases, the elongated object is (and/or comprises a portion that is) rectangular, ovoid, elliptical, triangular, zig zag shaped, single strapped, double strapped, triple strapped, wire shaped, polygonal, symmetrical, asymmetrical, cord shaped, netted, molded to any suitable shape, extruded to any suitable shape, formed to any suitable shape, intertwined, cup shaped, joined to another strap and/or any other suitable object, and/or that is any other suitable shape. By way of non-limiting illustration, FIGS. 1A-1I show some embodiments in which the elongated object 25 comprises a substantially flat strip of plastic, leather, cloth, rubber, and/or any other suitable material that is configured to bend around a user's ear.

In some embodiments, the elongated object 25 is substantially C-shaped; U-shaped; J-shaped; shaped to contour around a user's ear; comprises one or more extensions for decoration, improved electronic signal, to stabilize the elongated object, and/or for any other suitable purpose; comprises one or more hooks, cups, catches, and/or other objects that are configured to extend over, rest on top of, and/or otherwise couple to a user's ear; and/or is otherwise be relatively stiff, permanently shaped, and/or resiliently shaped to extend from an earphone 15 at a front of a user's ear to a back side of the user's ear. In some other embodiments, however, the elongated object comprises a flexible piece of material (e.g., a flexible strap, as illustrated in FIG. 1A). Nevertheless, in still other embodiments, the elongated object comprises one or more bendable objects that are configured to be bent and to then retain or substantially retain their shape. In this regard, the elongated object can comprise any suitable bendable material that is configured to substantially retain its shape (once bent) and that otherwise allows the earphone accessory 20 to function as described herein. By way of non-limiting example, some embodiments of the elongated object comprise, contain, consist of, are layered with, and/or otherwise include one or more bendable pieces of: metal (e.g., copper, aluminum, silver, gold, one or more metal alloys, wire, and/or any other suitable metal), a jointed material or object, plastic, ceramic, natural material, synthetic materials, and/or any other suitable material that is configured to be bent around a user's ear and to substantially maintain its shape after such bending. In still other embodiments, various portions of the elongated object have different characteristics (e.g., being stiff, flexible, resilient, etc.).

The elongated object 25 or strap can be any suitable length that allows it to function as described herein. In some embodiments, the strap is between about 2 cm and about 12 cm long (or has any other length that falls within such range). Indeed, in some embodiments, the elongated object has a length of between about 2.5 cm and about 7.5 cm (e.g., about 5 cm±1 cm).

The elongated object 25 or strap can be any suitable width that allows it to function as described herein. In some embodiments, the strap is between about 0.05 cm and about 10 cm wide (or has any other width that falls within such range). Indeed, in some embodiments, the elongated object has a width of between about 0.5 cm and about 2 cm (e.g., about 1 cm±0.5 cm).

The earphone accessory 20 can comprise any suitable number of elongated objects 25 or straps that allows the accessory to function as described herein. Indeed, in some embodiments, the accessory comprises 1, 2, 3, 4, 5, 6, 7, 8, 9, or more straps. By way of non-limiting illustration, FIGS. 1A-1I show some embodiments in which the earphone accessory 20 comprises a single elongated object 25 that is configured to couple to and extend from the earphone 15. In some additional embodiments, however, the accessory comprises one or more pieces of netting, cups, hooks, and/or other objects that sit on top of, rest on, sit in, clamp to, surround a portion of, and/or that are otherwise associated with a user's ear.

Any suitable portion of the elongated object 25 can couple to the earphone 15. Indeed, in some embodiments, a first end, a second end, a middle portion, off-center portion, side, and/or any other suitable portion of the elongated object is coupled to the earphone (and/or a cord of the earphone). In some embodiments, however, only a single end of the elongated object is coupled to the earphone (and not to a cord of the earphone). By way of non-limiting illustration, FIGS. 1A-1I show that, in some embodiments, a first end 40 of the elongated object 25 is coupled to the earphone 15.

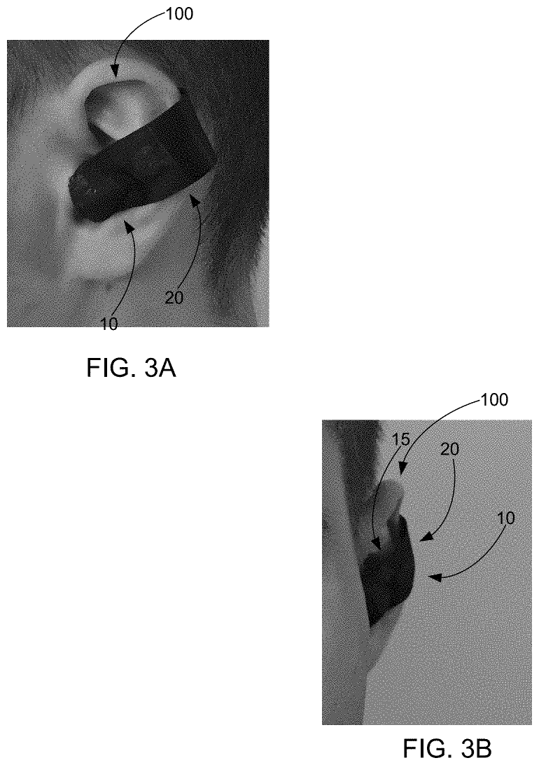

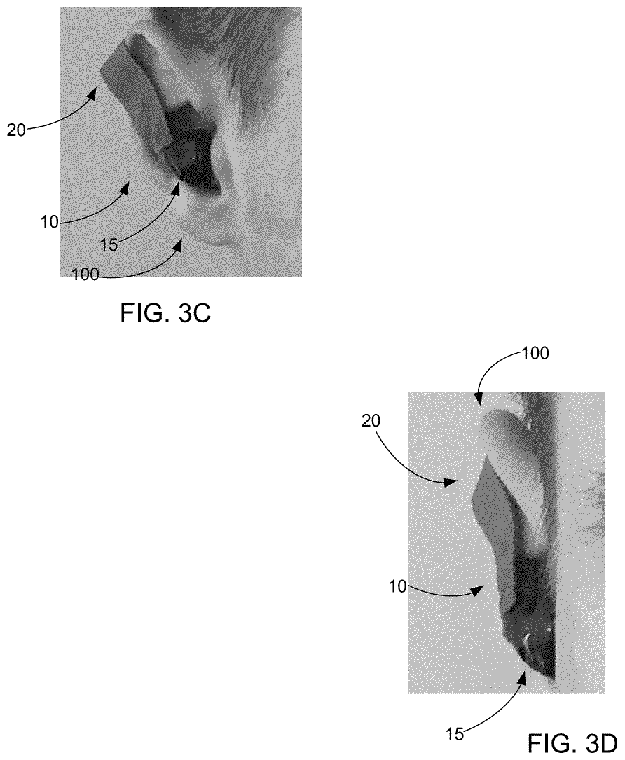

The elongated object 25 can be configured to extend around any suitable portion of a user's ear, including, without limitation, by extending around the user's earlobe, over a top of the user's ear, around a side of the user's ear, extending around multiple portions of the user's ear (e.g., via one or more straps and/or in any other suitable manner), and/or in any other suitable manner that allows the elongated object to function as described herein. By way of non-limiting illustration, FIG. 2A shows an embodiment in which the earphone accessory 20 is configured to extend around a lower portion of a user's ear 100. FIG. 2B shows an embodiment in which the earphone accessory 20 extends around a portion of a user's earlobe 105. Additionally, FIGS. 3A-3D show some embodiments in which the earphone accessory 20 extends over an upper, side portion of the user's ear 100.

In addition to the aforementioned features, the elongated object 25 (or strap) can comprise any other suitable feature. In one example, the elongated object comprises one or more decorative features, including, without limitation, one or more logos, flags, icons, words, team colors, advertisements, camo patterns, patterns, textures, colors, jewels, attachments, embellishments, lights (e.g., battery charge indicators, message indicators, etc.), extensions, reflectors, displays, and/or any other suitable decorative feature or features. In some embodiments, the elongated object comprises one or more reflective, fluorescent, and/or glow in the dark materials (e.g., so as to help a user be seen in relatively dark conditions).

In another example, some embodiments of the elongated object 25 comprise one or more conductive materials that are configured to be electrically coupled to a power source of the earphone 15 when the earphone accessory 20 (e.g., the elongated object) is coupled to the earphone. In this regard, the elongated object can comprise any suitable conductive material, including, without limitation, one or more pieces of copper, aluminum, sliver, gold, iron, steel, brass, bronze, and/or any other suitable conductive material. Additionally, while such conductive material can have any suitable shape (e.g., being coiled, nested, straight, elongated, curved, spiraled, curled, symmetrical, asymmetrical, intertwined, flattened, and/or any other suitable shape), FIGS. 1E, 1H, and 1I show some embodiments in which the conductive material 45 comprises one or more conductive wires, ribbons, gels, and/or other suitable element or elements that extend throughout a length (including portion of the length) of the elongated object 25. In this regard, such elements can be positioned at any suitable site with respect to the accessory, including, without limitation, being disposed toward a center of the accessory, being disposed toward one or more edges of the accessory, comprising the whole (or at least a significant portion) of the accessory, being non-contiguous throughout a portion of the accessory, being contiguous throughout a portion of the accessory, and/or in any other suitable location.

As another example of a suitable component of the elongated object 25, in addition to or in place of the conductive material 45, some embodiments of the elongated object comprise one or more antennas (e.g., as illustrated by antenna 50 in FIG. 1I) that are configured to be in signal communication with the earphone 15 (e.g., to improve reception) when the earphone accessory 20 is coupled to the earphone. In this regard, such antennas can comprise any suitable feature. By way of non-limiting illustration, FIG. 1I shows an embodiment in which the antenna 50 extends throughout a length of the elongated object 25.

In yet another example of a suitable component, in some cases, the elongated object 25 comprises one or more batteries (e.g., batteries 55, as illustrated in FIG. 1I) that are configured to be in electrical communication with the earphone 15 when the earphone accessory 20 is coupled to the earphone. Thus, in some embodiments, a user can switch out uncharged batteries for charged batteries simply by removing one earphone accessory with an uncharged battery and by connecting another earphone accessory having a charged battery to the earphone.

Turning now to the earphone coupler 30, the earpiece 10 can comprise any suitable coupling mechanism that is configured to couple the earphone accessory 20 (e.g., the elongated object 25) to the earphone 15. Indeed, in some embodiments, the earphone coupler comprises a permanent connection mechanism that permanently connects the earphone to the earphone accessory. For instance, in some cases, the earphone accessory is integrally formed with, permanently pinched in, permanently adhered to, melted to, welded to, permanently snapped to, permanently plugged together with, permanently and frictionally coupled to, permanently and mechanically coupled to, and/or otherwise permanently coupled with the earphone.

In some other cases, however, the earphone coupler 30 is configured to selectively couple the earphone accessory 20 to (and to selectively decouple it from) the earphone 15. In this regard, the earphone coupler can comprise any suitable coupling mechanism that is configured to function in such a manner, including, without limitation, one or more mechanical engagements, frictional engagements, catches, magnets, claps, male to female connectors (magnetic or otherwise), detent mechanisms, pawls, clips, pins, hook and loop fasteners, adhesives, stick materials, plug couplings, snaps, clip connections, threaded coupling mechanisms, electrical couplers, electrical contacts, plugs, and/or other suitable coupling mechanisms that allow the earphone accessory to selectively physically couple (and, in some cases, to electrically, signally, and/or otherwise couple, depending on whether or not the accessory comprises one or more conductive materials 45, antennas 50, and/or batteries 55) with, and to decouple from, the earphone.

In this regard, earphone accessory 20 can couple to the earphone 15 at any suitable location. Indeed, in some embodiments, the accessory couples to a front; back; side; top; bottom; end; and/or any other suitable portion of the earphone, of an extension, and/or of any other suitable object that couples to the earphone; and/or in any other suitable location.

Indeed, in some embodiments, the earphone coupler 30 comprises one or more magnetic clasps that are configured to couple together. By way of non-limiting illustration, FIGS. 1C and 1F show some embodiments in which the earphone coupler 30 comprises one or more magnetic clasps 60. Additionally, FIGS. 1D and 1G show some embodiments in which the one or more of the earphone 15 and the earphone accessory 20 each comprise a male 65 and/or a female 70 coupler. In this regard, such couplers can couple together in any suitable manner, including, without limitation, via one or more magnets, detents, snaps, and/or other suitable mechanisms. Indeed, in some embodiments, the male component (which can be located on either the earphone or the earphone accessory) comprises a magnet and the female component comprises a magnetic material (or vice versa). In still another non-limiting illustration, FIG. 1E shows that the earphone coupler 30 comprises two components that are configured to slide together to couple with each other.

As previously mentioned, the earphone coupler 30 can be disposed in any suitable location on the elongated object 25, including, without limitation, at one end of the elongated object, at two ends of the elongated object, along a side of the elongated object, at a center portion of the elongated object, at an off-center portion of the elongated object, and/or in any other suitable location. By way of non-limiting illustration, FIGS. 1C-1E show some embodiments in which at least a portion of the earphone coupler 30 is disposed at a first end portion 40 of the elongated object 25.

With reference now to the magnetic coupling mechanism 35, the earpiece 10 can comprise any suitable magnetic coupling mechanism that allows the elongated object 25 to extend around a portion of the user's ear and to magnetically couple with another portion of the elongated object and/or the earphone 15, through the user's ear. In some such cases, the magnetic coupling mechanism comprises any suitable number of magnetic couplers (e.g., 1, 2, 3, 4, 5, 6, 7, 8, 9, or more) that allow it to function in such a manner. By way of non-limiting illustration, FIGS. 1C-1I show some embodiments in which the magnetic coupling device 35 comprises a first magnetic coupler 70 that is configured to magnetically couple with a second magnetic coupler 75, a third magnetic coupler 80, and/or any other suitable number of magnetic couplers, through a user's ear (not shown in such drawings). Indeed, while FIGS. 1E, 1H, and 1I show some embodiments in which a first discrete magnetic coupler 70 can magnetically couple with one or more other discrete magnetic couplers (e.g., 75, 80, etc.), FIGS. 1C-1D and 1F-1G show some embodiments in which a first magnetic coupler 70 is able to magnetically couple at virtually any location along a length of a second discrete bendable (or bent) magnetic coupler 75. In still other embodiments, an elongated and bent or bendable magnet that is included with the elongated object 25 is configured to bend to magnetically couple with itself. Thus, in some embodiments, the magnetic coupler is configured to be adjustable to magnetically couple in multiple positions, to allow the earphone accessory 20 to be comfortably coupled to ears of a wide variety of sizes and with a wide variety of characteristics (e.g., anatomical characteristics, piercings, etc.).

Where the magnetic coupling mechanism 35 comprises one or more magnetic couplers, the magnetic couplers can comprise any suitable type of magnets and/or corresponding magnetic materials, including, without limitation, ferromagnetic materials, paramagnetic materials, and/or any other suitable materials that are attracted to a magnet used in a magnetic coupler and that are suitable for use with the earpiece 10). Some non-limiting examples of such magnets comprise any suitable type of magnets, including, without limitation, one or more magnets comprising neodymium-iron boron, samarium-cobalt, one or more ceramics, one or more ferrites, one or more sintered composites comprising powdered iron oxide and barium/strontium carbonate ceramic, alnico, magnetite, lodestone, cobalt, nickel, iron, gadolinium, dysprosium, one or more iron alloys, one or more types of steel, one or more rare earth metals, one or more pieces of magnetic tape, one or more strips of magnets, one or more magnetic gels, one or more cushions or pads comprising a magnetic materials, and/or any other suitable type of material or materials that have magnetic properties and are attracted to one or more magnetic materials (as discussed below). Additionally, where the magnetic couplers comprise one or more magnetic materials, such materials can comprise any suitable material, including, without limitation, one or more pieces of iron, nickel, cobalt, magnet, and/or any other suitable ferromagnetic, paramagnetic, and/or other material that is attracted to a magnet in a magnetic coupler and that is suitable for use in the earpiece 10. Indeed, in some embodiments the earphone accessory comprises at least one magnet and one or more separate magnets and/or magnetic materials.

Where the earpiece 10 comprises one or more magnetic coupling devices 35, the magnets and/or magnetic couplers of such devices can be disposed in any suitable location, including, without limitation, on one or more sides of the earphone 15, between a first end 40 and a second end of the earphone accessory 20, on the earphone accessory and on the earphone (and/or on a wire of the earphone), and/or in any other suitable location. In accordance with some embodiments, however, FIGS. 1A-1I show that the magnetic coupling device 35 is included with the elongated object 25 between the earphone coupler 30 and a second end portion 85 of the elongated object. Indeed, FIGS. 1A-1I show that, in some embodiments, a first magnet (and/or magnetic material) 70 is disposed at a second end portion 85 of the elongated object 25, and an additional magnet (or magnetic material) 75, 80, etc. is disposed between the earphone coupler 30 and the second end 85 (or first magnet 70) of the elongated object 25. In accordance with some embodiments, such placement allows the earphone accessory to place pressure on the ear (e.g., caused by the coupling of the magnetic coupling mechanism) to be included in a variety of portions of the ear (e.g., portions of the ear that have few nerves or little feeling).

In addition to the aforementioned components, the described earpiece 10 can have any other suitable component or characteristic that allows it to function as intended. In one example, some embodiments of the magnetic coupling mechanism 35 optionally include one or more cushions, pads, and/or other features that are configured to prevent the magnetic coupling mechanism from placing too much pressure on a portion of a user's ear and/or to otherwise make the earphone accessory more comfortable to use. Indeed, in some embodiments, the magnetic couplers comprise one or more portions of a magnetic gel and/or a magnet covered by a pad or cushion.

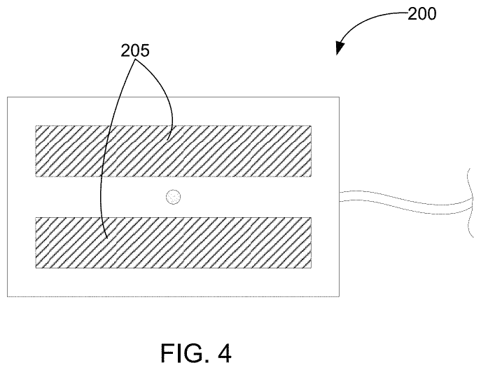

As another example, some embodiments of the described earpiece 10 are configured to be used to be used with one or more chargers. Indeed, in some embodiments, the earpiece and/or the earphone accessory 20 are configured to physically and electrically couple to a charger (e.g., via one or more wires, cords, plugs, and/or electrical contacts). In some other embodiments, however, the earphone accessory (e.g., a battery 55 in the elongated object) and/or the earphone 15 are charged inductively.

Where the earphone accessory 20 and/or earphone 15 are configured to be charged by inductively, the corresponding inductive charger can have any suitable characteristic or feature. Indeed, in some example, the charger comprises one or more magnets that are configured to magnetically attract the earphone accessory (e.g., the magnetic coupling mechanism of the accessory). In another example, the charger comprises one or more grooves, slots, depressions, and/or catches that are configured to fit one or more of the earphone accessories (e.g., with or without the earphone) to allow a user to readily place the earphone accessories on the charger in an organized manner. By way of non-limiting illustration, FIG. 4 shows an embodiment of an inductive charger 200 that defines two grooves 205 that are configured to magnetically hold the earphone accessories (not shown in FIG. 4) and to charge the earpiece 10 (not shown in FIG. 4) by inductively charging a battery in the earphone accessory 20, by inductively charging a battery of the earphone with the help of the conductive material 45 of the accessory, and/or by inductively charging a battery of the earphone without the help of a conductive material of the accessory.

The described earpiece 10 and charger 200 can be modified in any suitable manner. Indeed, in some embodiments, the earphone accessory 20, the earphone 15, and/or the charger are configured to communicate (e.g., their status, charge, operation time, operation function being performed, sensor readings, and/or any other suitable information) to one or more computers (e.g., smartphones, wearable devices, laptops, etc.) via a wired and/or a wireless connection method (e.g., as described below).

In another example, the earphone 15 and/or the earphone accessory 20 comprise one or more sensors, including, without limitation, one or more pedometers, thermometers, heart rate monitors, pulse oximeters, EKG sensors, inertial measurement unit, micro-electro-mechanical systems (MEMS), electrochemical biosensors, wearable electrodes, EEG sensors, EMG sensors, perspiration sensors, oxygen sensors, accelerometers, SPO2 sensors, altimeters, barometers, GPS sensors (and/or any other suitable positional sensors), and/or any other suitable sensor or sensors. Indeed, in some embodiments, placement of such a sensor on or near a user's ear can avoid many of the challenges that are associated with placing such sensors on a user's wrist (e.g., the inability of a wrist pedometer to properly count steps when a user is pushing a stroller or shopping cart, excess hand movements skewing proper readings, etc.).

As another example, some embodiments of the earphone accessory 20 and/or the earphone 15 comprise one or more processors (e.g., as described below) that are configured to gather, sort, process, analyze, and/or otherwise use information from the sensors, and/or to otherwise control the earpiece 10.

In still another example, some embodiments of the accessory 20 comprise one or more controls (e.g., volume controls, power controls, and/or any other suitable controls) that allow the user to control a corresponding earphone 15.

In yet another example of a suitable modification, some embodiments of the accessory 20 comprise one or more wireless communication devices (e.g., Bluetooth devices, infrared devices, radio devices, RFIDs, RFID scanners, and/or other wireless communication devices) that allow the accessory to pass information to (and/or to receive information from) another electronic device (e.g., the cloud, a server, a cellphone, a laptop, a tablet, and/or any other suitable device in any suitable location).

As still another example of a suitable modification, in some embodiments, the earphone 15 and/or the accessory 20 are configured to determine (e.g., via RFID, Bluetooth signal, WiFi signal, infrared communication, radio signal, microphone, and/or any other suitable method or device) when a first user who is wearing an embodiment of the described earpiece 10 in proximity to (and/or is attempting to talk to) one or more other people who are using an embodiment of the described earpiece (and/or any other suitable earpiece). Indeed, in some such embodiments, when the described earpiece determines that its user is trying to verbally communicate with another person (e.g., another person using an embodiment of the described earpiece), such earpieces can automatically mute themselves, reduce the sound level they produce, turn on one or more microphones to amplify such communications, and/or take any other suitable action that helps the user communicate with others. For instance, when two people using the described earphone at a gym try to talk to each other, some embodiments of the described device are configured to automatically reduce the sound level of the music (and/or other audio) that is being played through the earphones to allow such people to communicate with each other.

In some such embodiments, the described system 10 is configured to perform such a function without necessarily requiring such users to take any actions with their hands (e.g., without touching any sensors or switches, without holding a hand over the earphone, and/or without otherwise requiring the user to reduce the sound produced by the system). Additionally, in some embodiments, when the described systems and methods determine that a user is no longer trying to verbally communicate with another, some such systems automatically unmute the earphone and/or increase the earphone's sound level.

As still another example of a suitable modification, in some embodiments, the described earpiece 10 comprises one or more location sensors (e.g., GPS sensors and/or any other suitable location sensor) that allow for a person to track the movement of (e.g., during running, hiking, driving, swimming, and/or any other suitable movement) and/or to otherwise locate the earpiece (e.g., when it has been lost, stolen, and/or in any other suitable circumstances in which it is helpful or desirable to determine the location of the earpiece (e.g., the earphone 15 and/or the accessory 20).

As still another example of a suitable modification, some embodiments of the described system 10 (e.g., the earphone 15 and/or accessory 20) are configured to heat and/or cool a user's ear. In this regard, the system can heat and/or cool the user's ear in any suitable manner, including, without limitation, by comprising one or more heating elements, cooling elements, fans, fluid heating systems, fluid cooling systems, fluid pumping systems, pumps, materials that are configured to dissipate heat, materials that are configured to absorb heat, heat sinks, materials having a relatively low specific heat, materials having a relatively high specific heat, temperature sensors, temperature controls, and/or any other suitable component that allows one or more portions of the system to selectively, manually, and/or automatically heat and/or cool a portions of the user's ear. Thus, in some such embodiments, the described system is configured to allow a user to comfortably wear the system under a wide variety of conditions (e.g., in the cold, in the heat, when exercising, and/or at any other suitable time or place).

The described earpiece 10 and/or charger 200 can be made in any suitable manner. In this regard, some non-limiting examples of methods for making the described accessory 20, earphone 15, charger, and/or any other component described herein include, cutting, folding, bending, molding, shaping, extruding, drilling, coiling, soldering, using a computer numerical control device, connecting various pieces with one or more adhesives, mechanical fasteners (e.g., clamps, rivets, crimps, pins, brads, nails, staples, pegs, clips, screws, bolts, threaded attachments, catches, couplers, etc.), 3D printing, additive manufacturing, welding pieces together, connecting pieces together, and/or any other suitable method that allows the described system (and its various components) to function as described herein.

In addition to the aforementioned features, the described system 10 can have any other suitable feature. Indeed, in some embodiments, the earphone accessory 20 can reliably hold an earphone 15 in place, no matter how active the wearer is. Moreover, in some embodiments, the describe earphone accessory can properly secure an earphone while being comfortable use, even for extended times, and even with ears of a wide variety of sizes and with a wide variety of differing characteristics. Indeed, in some embodiments, the accessory can be positioned in virtually any location on a user's ear (e.g., to accommodate piercings, anatomical features, user preferences, and/or a variety of other features).

In some embodiments, the described system 10 is configured to stay coupled to a user's ear (and/or any other suitable object) in a wide variety of conditions (e.g., during running, climbing, swimming, sailing, inclement weather, storms, and/or under a variety of other relatively pleasant and/or harsh conditions).

In some embodiments, the described system 10 (e.g., the earphones 15 and/or the accessory 20) are waterproof (e.g., for use during swimming, sailing, running in the rain, and/or a variety of other uses involving water).

In still other embodiments, the described system 10 (e.g., the earphones 15 and/or the accessory) are sized and shaped to prevent debris and/or other materials from entering into a user's ear. Thus, some such embodiments of the system are configured to be used in sand storms, wind storms, snow storms, dusty areas, and/or in under any other suitable conditions in which it may be preferable to prevent debris from entering into the user's ears.

Additionally, in some embodiments, a single set of earphones 15 can be used with any suitable number of earphone accessories 20. For instance, a user could easily switch out a pair of earphone accessories that are used for exercise with a pair that go with business attire. Similarly, a user could switch out one accessory with an uncharged battery, with another accessory having a charged battery.

Moreover, in some embodiments, by having a reflective (and/or otherwise easily seen) element, the accessory 20 can help protect its user from not being seen.

As still other example of a suitable feature, some embodiments of the accessory 20 help the earphone 15 have better reception, longer battery life, to charge faster, and/or otherwise improve functioning of the earphone.

In still another example, some embodiments of the accessory 20 comprise a bendable component (e.g., outer margins of the elongated object comprising a malleable material next to a magnetic material) to allow the accessory to be magnetically coupled to a user's ear, while closely following contours of such ear.

### Representative Operating Environment

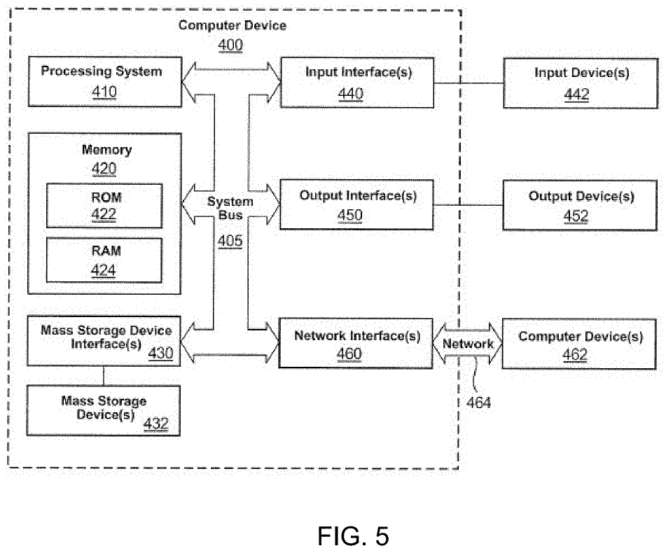

The described earpiece system 10 and/or charger 200 can be used with or in any suitable operating environment and/or software. In this regard, FIG. 5 and the corresponding discussion are intended to provide a general description of a suitable operating environment in accordance with some embodiments of the described systems and methods. As will be further discussed below, some embodiments embrace the use of one or more processing (including, without limitation, micro-processing) units in a variety of customizable enterprise configurations, including in a networked configuration, which may also include any suitable cloud-based service, such as a platform as a service or software as a service.

Some embodiments of the described systems and methods embrace one or more computer readable media, wherein each medium may be configured to include or includes thereon data or computer executable instructions for manipulating data. The computer executable instructions include data structures, objects, programs, routines, or other program modules that may be accessed by one or more processors, such as one associated with a general-purpose processing unit capable of performing various different functions or one associated with a special-purpose processing unit capable of performing a limited number of functions. In this regard, in some embodiments, the processing unit (e.g., as mentioned above) comprises a specialized processing unit that is configured for use with the described system 10.

Computer executable instructions cause the one or more processors of the enterprise to perform a particular function or group of functions and are examples of program code means for implementing steps for methods of processing. Furthermore, a particular sequence of the executable instructions provides an example of corresponding acts that may be used to implement such steps.

Examples of computer readable media (including non-transitory computer readable media) include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing unit.

With reference to FIG. 5, a representative system includes computer device 400 (e.g., a smartphone, an MP3 player, in the earphone accessory 20, in the earphone, and/or any other suitable unit), which may be a general-purpose or special-purpose computer (or processing unit). For example, computer device 400 may be an MP3 player, a personal computer, a notebook computer, a PDA or other hand-held device, a workstation, a minicomputer, a mainframe, a supercomputer, a multi-processor system, a network computer, a processor-based consumer device, a cellular phone, a tablet computer, a smart phone, a feature phone, a smart appliance or device, a control system, or the like.

Computer device 400 includes system bus 405, which may be configured to connect various components thereof and enables data to be exchanged between two or more components. System bus 405 may include one of a variety of bus structures including a memory bus or memory controller, a peripheral bus, or a local bus that uses any of a variety of bus architectures. Typical components connected by system bus 405 include processing system 410 and memory 420. Other components may include one or more mass storage device interfaces 430, input interfaces 440, output interfaces 450, and/or network interfaces 460, each of which will be discussed below.

Processing system 410 includes one or more processors, such as a central processor and optionally one or more other processors designed to perform a particular function or task. It is typically processing system 410 that executes the instructions provided on computer readable media, such as on the memory 420, a magnetic hard disk, a removable magnetic disk, a magnetic cassette, an optical disk, or from a communication connection, which may also be viewed as a computer readable medium.

Memory 420 includes one or more computer readable media (including, without limitation, non-transitory computer readable media) that may be configured to include or includes thereon data or instructions for manipulating data, and may be accessed by processing system 410 through system bus 405. Memory 420 may include, for example, ROM 422, used to permanently store information, and/or RAM 424, used to temporarily store information. ROM 422 may include a basic input/output system (“BIOS”) having one or more routines that are used to establish communication, such as during start-up of computer device 400. RAM 424 may include one or more program modules, such as one or more operating systems, application programs, and/or program data.

One or more mass storage device interfaces 430 may be used to connect one or more mass storage devices 432 to the system bus 405. The mass storage devices 432 may be incorporated into or may be peripheral to the computer device 400 and allow the computer device 400 to retain large amounts of data. Optionally, one or more of the mass storage devices 432 may be removable from computer device 400. Examples of mass storage devices include hard disk drives, magnetic disk drives, tape drives, solid state mass storage, and optical disk drives.

Examples of solid state mass storage include flash cards and memory sticks. A mass storage device 432 may read from and/or write to a magnetic hard disk, a removable magnetic disk, a magnetic cassette, an optical disk, or another computer readable medium. Mass storage devices 432 and their corresponding computer readable media provide nonvolatile storage of data and/or executable instructions that may include one or more program modules, such as an operating system, one or more application programs, other program modules, or program data. Such executable instructions are examples of program code means for implementing steps for methods disclosed herein.

One or more input interfaces 440 may be employed to enable a user to enter data (e.g., initial information) and/or instructions to computer device 400 through one or more corresponding input devices 442. Examples of such input devices include a control pad, keys, a keyboard, and/or alternate input devices, such as a wearable device, a digital camera, a sensor, bar code scanner, debit/credit card reader, signature and/or writing capture device, pin pad, touch screen, mouse, trackball, light pen, stylus, or other pointing device, a microphone, a joystick, a game pad, a scanner, a camcorder, and/or other input devices. Similarly, examples of input interfaces 440 that may be used to connect the input devices 442 to the system bus 405 include a serial port, a parallel port, a game port, a universal serial bus (“USB”), a firewire (IEEE 1394), a wireless receiver, a video adapter, an audio adapter, a parallel port, a wireless transmitter, or another interface.

One or more output interfaces 450 may be employed to connect one or more corresponding output devices 452 to system bus 405. Examples of output devices include a monitor or display screen, a speaker, a wireless transmitter, a printer, and the like. A particular output device 452 may be integrated with or peripheral to computer device 400. Examples of output interfaces include a video adapter, an audio adapter, a parallel port, and the like.

One or more network interfaces 460 enable computer device 400 to exchange information with one or more local or remote computer devices, illustrated as computer devices 462, via a network 464 that may include one or more hardwired and/or wireless links. Examples of the network interfaces include a network adapter for connection to a local area network (“LAN”) or a modem, BLUETOOTH™, WiFi, a cellular connection, a wireless link, or another adapter for connection to a wide area network (“WAN”), such as the Internet. The network interface 460 may be incorporated with or be peripheral to computer device 400.

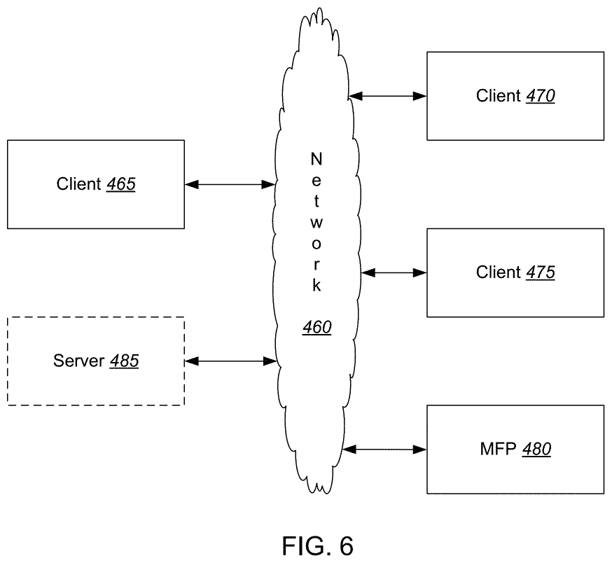

In a networked system, accessible program modules or portions thereof may be stored in a remote memory storage device. Furthermore, in a networked system computer device 400 may participate in a distributed computing environment, where functions or tasks are performed by a plurality networked computer devices. While those skilled in the art will appreciate that the described systems and methods may be practiced in networked computing environments with many types of computer system configurations, FIG. 6 represents an embodiment of a portion of the described systems in a networked environment that includes clients (465, 470, 475, etc.) connected to a server 485 via a network 460. While FIG. 6 illustrates an embodiment that includes 3 clients (e.g., earpiece systems 10, chargers 200, etc.) connected to the network, alternative embodiments include at least one client connected to a network or many clients connected to a network. Moreover, embodiments in accordance with the described systems and methods also include a multitude of clients throughout the world connected to a network, where the network is a wide area network, such as the Internet. Accordingly, in some embodiments, the described systems and methods can allow for remote: monitoring, training, communication, observation, control, adjustment, trouble shooting, data collecting, system optimization, user interaction, and/or other controlling of the earpiece system 10 and/or charger 200 from one or more places throughout the world.

Thus, some embodiments of the current invention relate to earpieces, such as earphones. More particularly, some implementations of the described invention relate to systems and methods for magnetically coupling an earpiece to a user's ear. While the described systems can include any suitable component, in some cases, they include an earphone and an earphone accessory. Generally, the earphone accessory includes an elongated object, an earphone coupler that is configured to couple the elongated object to the earphone, and a magnetic coupling mechanism. In some cases, the elongated object is configured such that, when a user is wearing the earphone coupled to the elongated object, the elongated object wraps around the user's ear, from the earphone at a front side of the user's ear to a back side of the user's ear. In some cases, the magnetic coupling mechanism is configured to magnetically couple a first portion of the elongated object to a second portion of the elongated object, through the user's ear, to selectively secure the earphone to the user's ear. In some cases, the magnetic coupling mechanism is configured to allow the elongated object to be magnetically coupled to itself in multiple locations, so as to allow the earphone accessory to be used with ears of a variety of sizes and with a variety of different characteristics.

The present invention may be embodied in other specific forms without departing from its spirit or essential characteristics. The described embodiments, examples, and illustrations are to be considered in all respects only as illustrative and not restrictive. The scope of the invention is, therefore, indicated by the appended claims rather than by the foregoing description. Each of the various elements of the described embodiments, implementations, figures, and examples can be mixed and matched with each other in any suitable manner. All changes that come within the meaning and range of equivalency of the claims are to be embraced within their scope. In addition, as the terms on, disposed on, attached to, connected to, coupled to, etc. are used herein, one object (e.g., a material, element, structure, member, etc.) can be on, disposed on, attached to, connected to, or coupled to another object—regardless of whether the one object is directly on, attached, connected, or coupled to the other object, or whether there are one or more intervening objects between the one object and the other object. Also, directions (e.g., front back, on top of, below, above, top, bottom, side, up, down, under, over, upper, lower, lateral, etc.), if provided, are relative and provided solely by way of example and for ease of illustration and discussion and not by way of limitation. Where reference is made to a list of elements (e.g., elements a, b, c), such reference is intended to include any one of the listed elements by itself, any combination of less than all of the listed elements, and/or a combination of all of the listed elements. Furthermore, as used herein, the terms a, an, and one may each be interchangeable with the terms at least one and one or more.

What is claimed is:

1. An earphone accessory comprising:
an elongated object that is configured to couple to an earphone and that is configured, when a user is wearing the earphone coupled to the elongated object, to wrap around an ear of the user, from the earphone at a front side of the user's ear to a back side of the user's ear;
an earphone coupler disposed at a first end of the elongated object, the earphone coupler being configured to couple the elongated object to the earphone; and
a magnetic coupling mechanism that is configured to magnetically couple a first portion of the elongated object to a second portion of the elongated object through the user's ear.

2. The earphone accessory of claim 1, wherein the earphone coupler is configured to selectively attach to and detach from the earphone.

3. The earphone accessory of claim 1, wherein the magnetic coupling mechanism comprises:
a first magnetic material disposed at a second end of the elongated object; and
a second magnetic material disposed along a length of the elongated object, between a the first end and the second end of the elongated object, wherein the first magnetic material and the second magnetic material are configured to be magnetically coupled together through the user's ear.

4. The earphone accessory of claim 1, wherein the elongated object comprises a conductive material that is configured to be electrically coupled with a power supply of the earphone when the elongated object is coupled to the earphone.

5. The earphone accessory of claim 1, wherein the magnetic coupling mechanism comprises multiple magnets that are disposed along a length of the elongated object.

6. The earphone accessory of claim 1, wherein the elongated object comprises a reflective material on the elongated object's outer surface.

7. The earphone accessory of claim 1, wherein the elongated object comprises a pliable material that is configured to be bent and to retain its bent shape.

8. The earphone accessory of claim 1, wherein the earphone coupler comprises a first magnetic material that is configured to magnetically couple with a second magnetic material of the earphone.

9. The earphone accessory of claim 1, wherein the earphone coupler is configured slidably couple with the earphone.

10. The earphone accessory of claim 1, wherein the earphone coupler is configured to mate with a coupling portion of the earphone.

11. An earpiece comprising:
an earphone; and
an earphone accessory comprising:
an elongated object that is configured to couple to an earphone and that is configured, when a user is wearing the earphone coupled to the elongated object, to wrap around an ear of the user, from the earphone at a front side of the user's ear to a back side of the user's ear, and
an earphone coupler disposed at a first end of the elongated object, the earphone coupler being configured to couple the elongated object to the earphone; and
a magnetic coupling mechanism that is configured to magnetically couple a first portion of the elongated object to a second portion of the elongated object through the user's ear.

12. The earpiece of claim 11, wherein the elongated object comprises a strip of a flexible material.

13. The earpiece of claim 11, wherein the elongated object comprises a resilient material.

14. The earpiece of claim 11, wherein the magnetic coupling mechanism comprises a first magnet that is configured to be disposed at the front side of the user's ear and a second magnet that is configured to be disposed at a second side of the user's ear when the earpiece is worn by the user.

15. The earpiece of claim 11, wherein the elongated object comprises an antenna that is in signal communication with the earphone.

16. The earpiece of claim 11, wherein the elongated object comprises a battery that is electrically connected with the earphone.

17. The earpiece of claim 11, wherein the elongated object comprises a conductive material that is electrically coupled to the earphone.

18. An earpiece comprising:
an earphone; and
an earphone accessory comprising:
an elongated object that is configured to selectively couple to and decouple from an earphone and that is configured, when a user is wearing the earphone coupled to the elongated object, to wrap around the user's ear from the earphone at a front side of the user's ear, to a back side of the user's ear, and
an earphone coupler disposed at a first end of the elongated object, the earphone coupler being configured to selectively couple the elongated object to and to selectively decouple the elongated object from the earphone; and
a magnetic coupling mechanism that is configured to magnetically couple a first portion of the elongated object to a second portion of the elongated object through the user's ear,
wherein the elongated object comprises an elongated conductor material that is configured to be electrically coupled with a power supply of the earphone when the elongated object is coupled to the earphone, and
wherein the magnetic coupling mechanism comprises:
a first magnetic material disposed at a second end of the elongated object; and
a second magnetic material disposed along a length of the elongated object, between the first end and the second end of the elongated object.

19. The earpiece of claim 18, wherein the elongated object comprises an antenna that is in signal communication with the earphone.

20. The earpiece of claim 18, wherein the elongated object comprises a battery that is electrically coupled to the earphone.
